(19) United States
(12) Patent Application Publication
(10) Pub. No.: US 2025/0229863 A1
(43) Pub. Date: Jul. 17, 2025

(54) SHOCK ABSORBER CONTROL SYSTEM USED IN SHOCK ABSORBER

(71) Applicant: Know Fast Smart Technology CO., LTD., Hsinchu City (TW)

(72) Inventors: CHIH-HAN LIN, Hsinchu City (TW); CHENG-CHUN TSAI, Hsinchu City (TW)

(21) Appl. No.: 18/669,056

(22) Filed: May 20, 2024

(30) Foreign Application Priority Data
Jan. 15, 2024 (TW) 113101572

(51) Int. Cl. B62K 25/06; B62K 25/04

(52) U.S. Cl. CPC B62K 25/06; B62K 2025/044

(57) ABSTRACT

A shock absorber control system used in a shock absorber has a resistance adjustment device, and the resistance adjustment device has a driving unit, a return detection unit and a control unit, and the driving unit is installed in a shell structure. The driving unit has a transmission part, an encoder and a stepper motor. The stepper motor adjusts a telescopic resistance of the shock absorber via the transmission part. The encoder senses a rotation angle of the stepper motor. The return detection unit senses a rotation position of the transmission part in relative to the shell structure. When the control unit is awakened, it firstly controls the stepper motor to rotate to decrease the rotation angle, and then when receiving a return signal of the return detection unit, the control unit control the stepper motor to rotate to the last recorded rotation angle.

### TECHNICAL FIELD

The present disclosure relates to a device for adjusting a shock absorber, and in particular, to a shock absorber control system for adjusting a telescopic resistance of the shock absorber.

### RELATED ART

Mountain bikes (or mountain bicycles) are usually equipped with front fork shock absorbers, and such front fork shock absorbers are provided with adjustment parts for users to adjust the shock absorption effect according to road conditions. However, when using these front fork shock absorbers currently, users usually have to manually adjust the telescopic resistances of the left and right shock absorbers of the front fork shock absorber with tools based on the type of the road that they are planning to ride on, that is, what the industry calls softening or hardening. However, this manner of manual setting by using tools is quite inconvenient and cannot be used to accurately adjust the required telescopic resistance.

### SUMMARY

Therefore, an object of the present disclosure is to provide a shock absorber control system for a shock absorber that can improve at least one shortcoming of the related art.

Accordingly, the present disclosure provides a shock absorber control system used in a shock absorber, the shock absorber comprises a telescopic pillar module and an adjustment pillar module for adjusting a telescopic resistance of the telescopic pillar module, and the shock absorber control system comprises a resistance adjustment device. The resistance adjustment device comprises a shell structure, a driving unit, a return detection unit and a control unit, the shell structure is installed in and fixed to the telescopic pillar module, and the driving unit is installed in the shell structure.

The driving unit comprises a transmission part, an encoder and a stepper motor, wherein the transmission part is connected to the adjustment pillar module, and the stepper motor is connected between the transmission part and encoder. The stepper motor is used to be controlled to operate and drive the transmission part, so that the transmission part drives the adjustment pillar module to adjust the telescopic resistance of the telescopic pillar module, and the encoder is used to sense a rotation angle of the stepper motor and generate an angle signal.

The return detection unit comprises a detector and a positioning part, wherein the detector is installed in the shell structure, the positioning part is installed in the transmission part and linked by the transmission part to rotate relative to the detector, and the detector is used to generate a return signal when the positioning part is detected by the detector. The control unit is installed in the shell structure and signally connected to the driving unit and the return detection unit. When the control unit is controlled to adjust the rotation angle of the stepper motor, the rotation angle corresponding to the angle signal is recorded. When the control unit is triggered by a wake-up signal, the control unit controls the stepper motor to rotate in a direction where the rotation angle becomes smaller until the control unit receives the return signal, and then the control unit controls the stepper motor to rotate to the last recorded rotation angle.

The effects of the present disclosure are described as follows. Through the structural design of the driving unit, the return detection unit and the control unit of the resistance adjustment device, the telescopic resistance of the shock absorber can be automatically and accurately adjusted, thereby accurately adjusting the shock absorption of the shock absorber.

### BRIEF DESCRIPTIONS OF DRAWINGS

Other features and effects of the present disclosure will be clearly presented in the embodiments with reference to the drawings. The drawings of the present disclosure are briefly described as follows.

FIG. 1 is a partial three-dimensional diagram which depicts a shock absorber control system installed in the shock absorber according to one embodiment of the present disclosure.

FIG. 2 is a partial side cross section diagram which depicts a shock absorber control system installed in the shock absorber according to one embodiment of the present disclosure.

FIG. 3 is a three-dimensional explosive diagram which depicts a structure of a resistance adjustment device according to one embodiment of the present disclosure.

FIG. 4 is a functional block diagram which depicts each component function of a shock absorber control system according to one embodiment of the present disclosure.

FIG. 5 is a view diagram similar to FIG. 2 but depicts a condition that a shock absorber is driven by a resistance adjustment device, so that a damping valve of a shock absorber is opened, according to one embodiment of the present disclosure.

FIG. 6 is a top view diagram which depicts a structure of a resistance adjustment device according to one embodiment of the present disclosure.

FIG. 7 is a curve diagram which depicts a relation of a gravity value and a rotation angle during riding a bicycle according to one embodiment of the present disclosure.

### DETAILS OF EXEMPLARY EMBODIMENTS

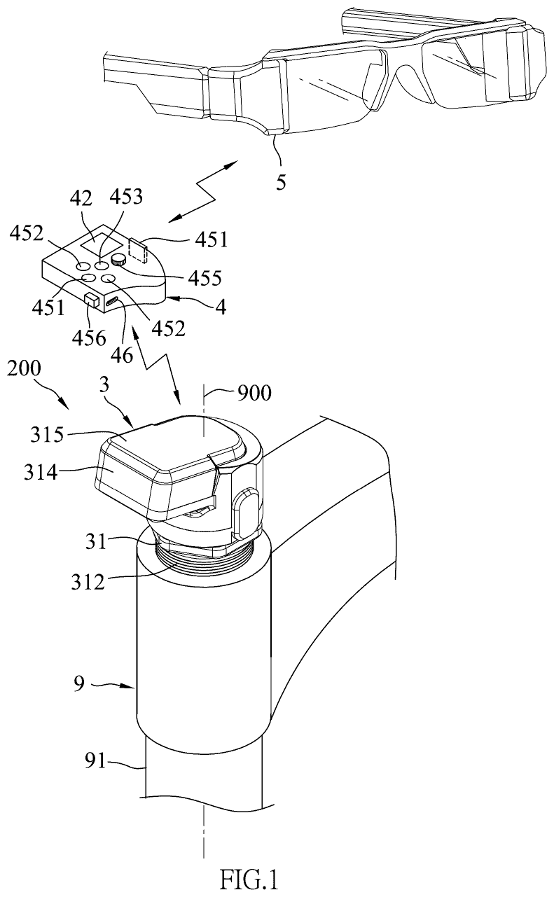

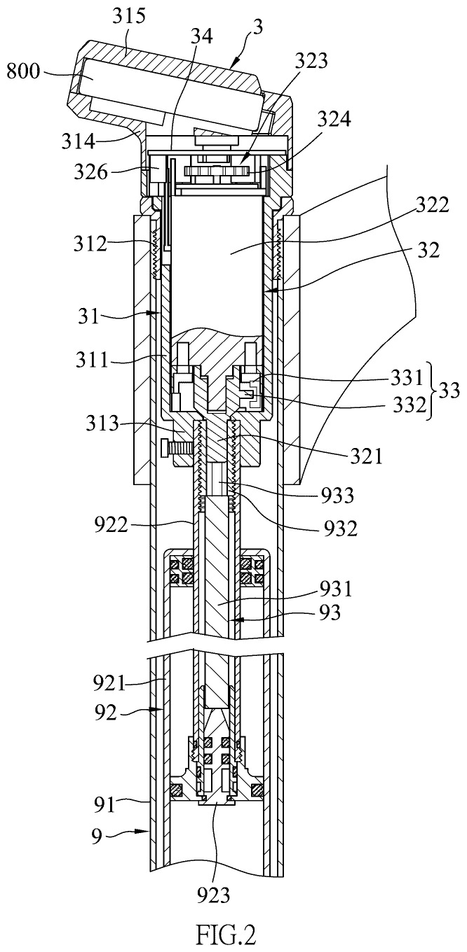

Refer to FIG. 1 and FIG. 2, a shock absorber control system 200 used in a shock absorber in one embodiment of the present disclosure is installed in a bicycle. The shock absorber control system 200 is connected to a shock absorber 9 of the bicycle. The shock absorber 9 is for example but not limited to a front fork shock absorber, a seat post shock absorber, or a rear fork shock absorber. In this embodiment, the shock absorber 9 is a front fork shock absorber as an example.

The shock absorber 9 comprises a shock absorber outer tube 91, a telescopic pillar module 92 and an adjustment pillar module 93. The shock absorber outer tube 91 extends up and down along an axis 900, the telescopic pillar module 92 is coaxially installed in and fixed to the shock absorber outer tube 91 and is driven to telescope up and down along the axis 900, and the adjustment pillar module 93 is inserted downward into the telescopic pillar module 92. The telescopic pillar module 92 comprises an outer cylinder 921, a telescopic pillar 922 and a damping valve 923. The telescopic pillar 922 is inserted telescopically into the outer cylinder 921, and the damping valve 923 is installed between the telescopic pillar 922 and the outer cylinder 921. The damping valve 923 can be driven by the adjustment pillar module 93 to change the opening range thereof, thereby adjusting the telescopic resistance of the telescopic pillar 922 and the outer cylinder 921. The adjustment pillar module 93 comprises an adjustment pillar 931 and a screw seat 932. The adjustment pillar 931 is coaxially inserted into the telescopic pillar 922 and connected to the damping valve 923, and the screw seat 932 is screwed in the adjusting pillar 931 and abuts against the top of the adjusting pillar 931. The screw seat 932 has an inner hexagon hole 933 disposed along the axis 900.

The shock absorber control system 200 comprises resistance adjustment device 3, a wireless remote controller 4 and an augmented reality (AR) glasses 5. The resistance adjustment device 3 is installed on the shock absorber 9, and resistance adjustment device 3, the wireless remote controller 4 is installed on the frame (not shown) of the bicycle and is wirelessly connected to the resistance adjustment device 3, and the AR glasses 5 is signally connected to the wireless remote controller 4 and is worn by the rider of the bicycle. During implementation, one resistance adjustment device 3 can be installed on each shock absorber 9 of the bicycle, and all resistance adjustment devices 3 can be signally connected to the wireless remote controller 4, so as to facilitate the wireless remote controller 4 remotely control the operation of these resistance adjustment devices 3.

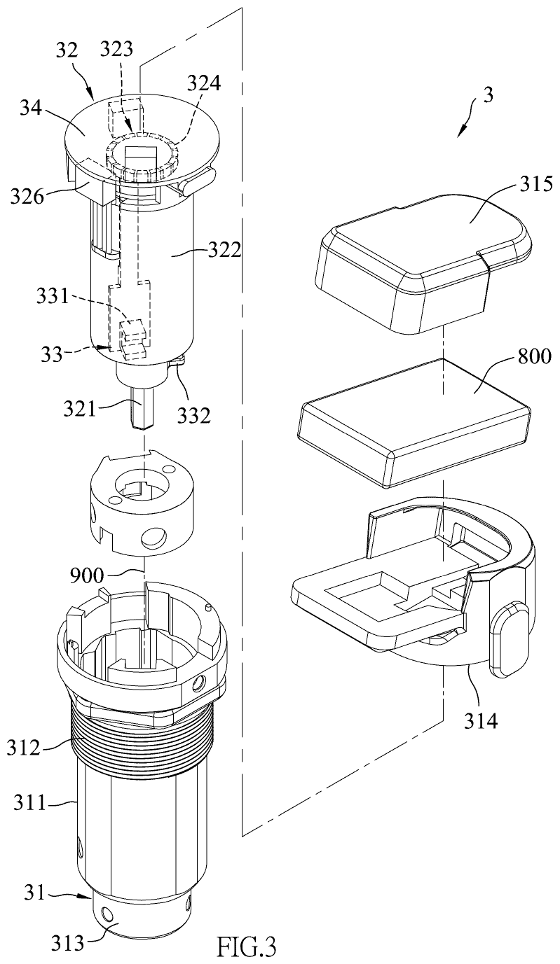

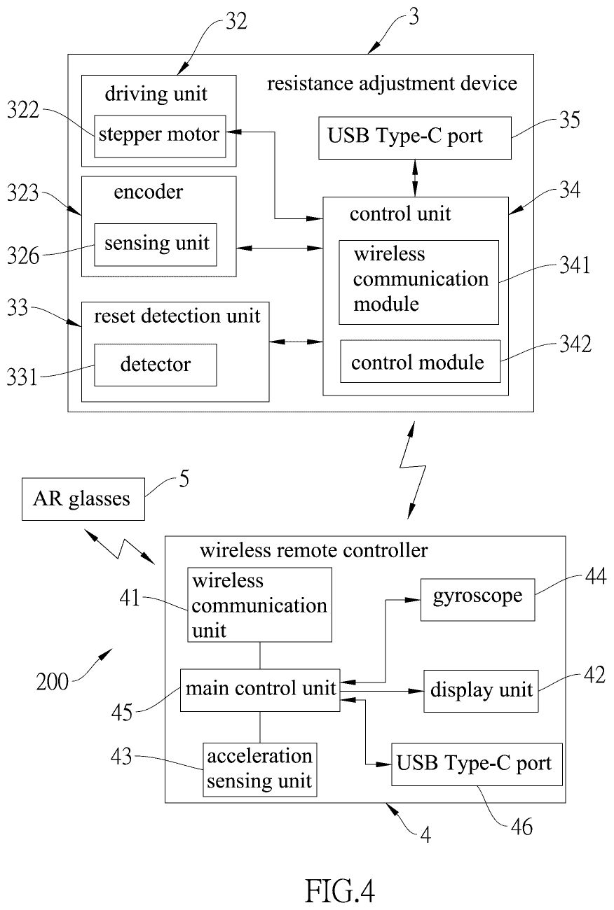

Refer to FIG. 2, FIG. 3 and FIG. 4, the resistance adjustment device 3 comprises a shell structure 31, a driving unit 32, a return detection unit 33, a control unit 34 and a USB Type-C port 35. The shell structure 31 is installed and fixed between the shock absorber outer tube 91 and the telescopic pillar 922, the driving unit 32 is installed in the shell structure 31 and connected to the screw seat 932, the return detection unit 33 is installed between the shell structure 31 and the driving unit 32, the control unit 34 is installed in the shell structure 31 and signally connected to the driving unit 32 and the return detection unit 33, and the USB Type-C port 35 is signally connected to the control unit 34.

The shell structure 31 comprises a shell body 311, a battery holder 314 and a battery cover 315. A battery holder 314 is installed on the top of the shell body 311 and electrically connected to a battery 800, and a battery cover 315 is installed on the battery holder 314 to cover the battery 800. The shell body 311 has a locking part 312 and a sleeve part 313. The locking part 312 is screwed and fixed inside the top end of the shock absorber outer tube 91, and the sleeve part 313 is sleeved and fixed outside the top end of the telescopic pillar 922.

The driving unit 32 comprises a transmission part 321, a stepper motor 322 and an encoder 323. The transmission part 321 is inserted into the inner hexagon hole 933 of the screw seat 932 so as to be displaceable up and down. The stepper motor 322 is connected to the transmission part 321, and the encoder 323 is connected to the top of the stepper motor 322. The rotation angle of the stepper motor is adjusted between 0 and 90 degrees, wherein the shock absorber has a maximum telescopic resistance when the rotation angle is 0 degree, and the shock absorber has a minimum telescopic resistance when the rotation angle is 90 degrees. The stepper motor 322 synchronously drives the transmission part 321 to rotate in a first rotation direction or a second rotation direction opposite to the first rotation direction, and then synchronously drives the screw seat 932 to rotate up and down in relative to the telescopic pillar 922. At this time, the transmission part 321 moves up and down in the inner hexagon hole 933 of the screw seat 932.

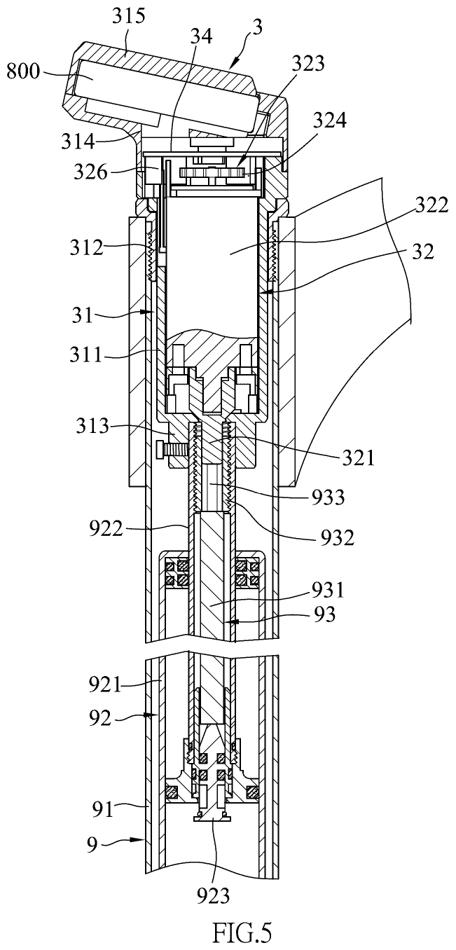

Refer to FIG. 2 and FIG. 5, and when the rotation angle of the stepper motor 322 is adjusted to rotate in the direction of 90 degrees, the screw seat 932 is driven to move downward in relative to the telescopic pillar 922, and the adjustment pillar 931 is driven to drive the damping valve 923 to be opened as shown in FIG. 5. Thus, the telescopic resistance of the shock absorber 9 is decreased, i.e., the shock absorption effect of the shock absorber 9 is increased. When the rotation angle of the stepper motor 322 is adjusted to rotate in the direction of 0 degree, the screw seat 932 is driven to move upward in relative to the telescopic pillar 922, and the adjustment pillar 931 is driven to drive the damping valve 923 to be closed as shown in FIG. 2. Thus, the telescopic resistance of the shock absorber 9 is increased, i.e., the shock absorption effect of the shock absorber 9 is decreased. Since the stepper motor has the characteristics of high precision and easy control, the telescopic resistance of the shock absorber 9 of the present disclosure is adjusted more accurately and finely by using the stepper motor 322 to control the up and down displacement of the screw seat 932.

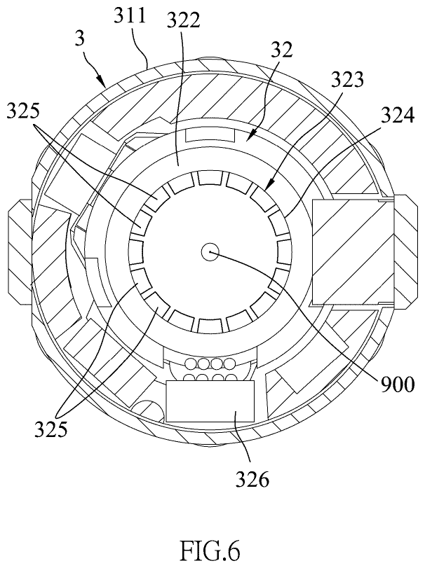

Refer to FIG. 3 and FIG. 6, and the encoder 323 can be used to sense the rotation angle of the stepper motor 322 and generate an angle signal accordingly. The encoder 323 comprises a coding disk 324 and a sensing unit 326. The coding disk 324 is rotatably installed and connected to the stepper motor 322, and the sensing unit 326 is disposed on the shell body 311 and is used to sense the rotation angle of the coding disk 324 to obtain the angle signal. In the embodiment, the encoder 323 is a magnetic induction encoder. The coding disk 324 has a plurality of magnets 325 arranged at equal angles. The sensing unit 326 is composed of a Hall sensing element. The sensing unit 326 senses the rotational displacement through the magnets 325, so as to generate the angle signal. In other embodiments of the present disclosure, the sensing unit 326 of the encoder 323 may also be an on-axis/off-axis magnetic rotary position sensor. In another embodiment of the present disclosure, the encoder 323 may also be an optical encoder. Since the encoder 323 has many types, it will not be described in detail, and the present disclosure is not limited by the above implementation.

Refer to FIG. 2 and FIG. 5, and the return detection unit 33 comprises a detector 331 and a positioning part 332. The detector 331 is installed in and fixed to the shell body 311, and the positioning part 332 is radially protruded on the outer peripheral surface of the transmission part 321. The positioning part 332 can be driven by the transmission part 321 to rotate in relative to the detector 331. The detector 331 can generate a return signal correspondingly when the positioning part 332 is sensed by the detector 331. In this embodiment, the detector 331 is a light-blocking optical sensor that can sense the light-blocking effect of the positioning part 332. However, in other implementation, the detector 331 may also be a light reflective optical sensor that senses the reflected light of the positioning part 332. Since there are many types of the detector 331 that can be used to sense the rotational displacement position of the positioning part 332, the detector 331 is not limited to the above-mentioned aspects during implementation. Similarly, the type of the positioning part 332 is also not limited to the above-mentioned aspects.

Refer to FIG. 1 to FIG. 4, and the control unit 34 comprises a wireless communication module 341 and a control module 342. The wireless communication module 341 can communicate wirelessly with the wireless remote controller 4 and is used to wirelessly receive a resistance adjustment signal and a wake-up signal transmitted by the wireless remote controller 4. The control module 342 can receive the angle signal and the return signal.

The control module 342 can be triggered by the resistance adjustment signal, and correspondingly controls the rotation angle of the stepper motor 322 according to the resistance adjustment signal. The control module 342 simultaneously analyzes the corresponding angle signal to obtain the rotation angle and records the rotation angle. The control module 342 can be triggered by the wake-up signal and controls the stepper motor 322 to rotate in the direction where the rotation angle becomes smaller until the return signal is received. Then, the control module 342 controls the stepper motor 322 to rotate in the direction where the rotation angle becomes larger until the rotation angle is equal to the last recorded rotation angle.

The USB Type-C port 35 can be used to be electrically connected to other electronic devices or charging devices to facilitate software updates and charging.

Since the insertion of the USB Type-C port 35 has no directionality, and the USB type- A and micro USB connectors have directionality, it can improve the previous problem that USB type-A and micro USB often take time to plug into the USB port correctly when adopting the USB Type-C port 35 design, and this makes it more convenient to use.

The maximum transmission efficiency of the USB Type-C port 35 can reach 10 Gbps. The USB Type-C port 35 supports fast charging and has a maximum output power of 100 watts.

The wireless remote controller 4 comprises a wireless communication unit 41, a display unit 42, an acceleration sensing unit 43, a gyroscope 44, a main control unit 45 and a USB Type-C port 46. The wireless communication unit 41 and the wireless communication module 341 can perform the data and signal transmission by using the currently known wireless communication technology, and the wireless communication unit 41 and the AR glasses 5 can perform the data and signal transmission by using the currently known wireless communication technology. The wireless communication technology, for example, is Bluetooth or Wi-Fi, and the present disclosure is not limited thereto.

The acceleration sensing unit 43 can be used to sense the acceleration variation and generate an acceleration signal accordingly. The gyroscope 44 can be used to sense angular momentum variation and generate an angular velocity signal accordingly. Since the acceleration sensing unit 43 and the gyroscope 44 are both existing components and can be implemented in many types, and they are not the focus of the improvement of the present disclosure, the acceleration sensing unit 43 and the gyroscope 44 are not described in detail.

The main control unit 45 comprises a power button 451, a plurality of fine adjustment buttons 452, a fully open button 453, a fully close button 454, a rotary knob 455, a stepless adjustment button 456 and a mode switching button, and the main control unit 45 is built-in with a multi-button control mode, a rotary knob control mode, a stepless control mode, a road mode, an off-road mode, and a customized mode, wherein the main control unit 45 can be activated and switched to one of the above modes. The main control unit 45 transmit the wake-up signal through the wireless communication unit 41 when the power button 451 is operated to turn on the wireless remote controller 4. The main control unit 45 can be switched to one of the multi-button control mode, the rotary knob control mode, the stepless control mode, the road mode, the off-road mode, and the customized mode when the mode switching button is operated, such that the main control unit 45 is operable to adjust the rotation angle of the stepper motor 322.

When the main control unit 45 is controlled to be switched to the multi-button control mode, the fine adjustment buttons 452, the fully open button 453 and the fully close button 454 are enabled, such that the fine adjustment buttons 452 can be used to be operated to adjust and set the rotation angle in small increments, a maximum rotation angle is able to be directly set by operating the fully open button 453, and a minimum rotation angle is able to be directly set by operating the fully close button 454. When the fine adjustment buttons 452 are operated every time, the main control unit 45 gradually increases or decreases the rotation angle by a predetermined value. For example, but not limited to, the rotation angle is increased or decreased by 5 degrees every time. The main control unit 45 generates the resistance adjustment signal according to the final adjustment setting of the rotation angle.

When the main control unit 45 is switched to the rotary knob control mode, the rotary knob 455 is enabled, allowing the rotation angle to be set by rotating the rotary knob 455, and the main control unit 45 generates the resistance adjustment signal according to the final setting of the rotation angle.

When the main control unit 45 is switched to the stepless control mode, the stepless adjustment button 456 is enabled, and the stepless adjustment button 456 can be adjusted in a gradually increasing or decreasing manner while the stepless adjustment button 456 is pressed. When the stepless adjustment button 456 stops being pressed, the adjustment of the rotation angle is stopped, and the resistance adjustment signal is generated according to the final rotation angle.

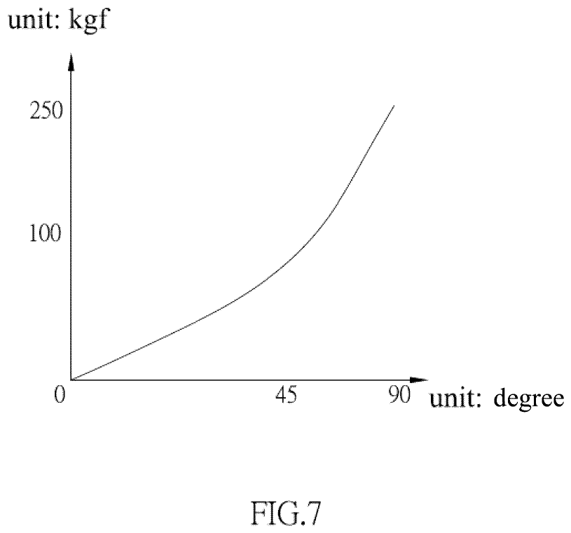

When the main control unit 45 is switched to the road mode, the main control unit 45 calculates and analyzes an acceleration represented by the acceleration signal and an angular velocity represented by the angular velocity signal at any time during the riding of the bicycle to obtain a gravity value (unit: kgf), and a predetermined function is used to calculate the corresponding rotation angle based on the gravity value. The main control unit 45 generates the resistance adjustment signal based on the rotation angle while the calculated rotation angle is between 0 and 45 degrees. Since it is an existing technology to obtain the gravity value through calculation and analysis of the acceleration and the angular velocity, it will not be described in detail. The curve shown in FIG. 7 is only an example of the predetermined function, and the implementation is not limited to this. The function between the weight value and the rotation angle can be adjusted and designed according to the shock absorption performance requirements of the shock absorbers of the various bicycles.

When the main control unit 45 is switched to the off-road mode, the main control unit 45 calculates and analyzes the acceleration represented by the acceleration signal and the angular velocity represented by the angular velocity signal at any time during the riding of the bicycle to obtain the gravity value, and the predetermined function is used to calculate the corresponding rotation angle based on the gravity value. The main control unit 45 generates the resistance adjustment signal based on the rotation angle while the calculated rotation angle is between 35 and 90 degrees.

When the main control unit 45 is switched to the customized mode, a lower limitation and an upper limitation of the rotation angle can be remotely set through an external device (not shown) signally connected to the main control unit 45. The external device may be, for example, but not limited to, a mobile phone or a device manufacturer's terminal device. The main control unit 45 calculates and analyzes the acceleration represented by the acceleration signal and the angular velocity represented by the angular velocity signal at any time during the riding of the bicycle to obtain the gravity value, and the predetermined function is used to calculate the corresponding rotation angle based on the gravity value. The main control unit 45 generates the resistance adjustment signal based on the rotation angle while the calculated rotation angle is larger than and equal to the lower limitation value and less than and equal to the upper limitation value.

When the main control unit 45 is switched to any of the above modes, the set rotation angle will be displayed synchronously on the display unit 42. When the main control unit 45 is switched to the road mode, the off-road mode and the customized mode, the currently calculated rotation angle is displayed on the display unit 42. In addition, after generating the resistance adjustment signal, the main control unit 45 immediately transmits the resistance adjustment signal to the wireless communication module 341 through the wireless communication unit 41, so that the control module 342 controls and adjusts the rotation angle of the stepper motor 322 according to the resistance adjustment signal. Thus, the telescopic resistance of the shock absorber 9 is adjusted, and that is, the shock absorption effect performance of the shock absorber 9 is adjusted.

Furthermore, the main control unit 45 also generates an AR display data based on the information of the currently switched and activated mode and the rotation angle which is generated based on which the resistance adjustment signal, and transmits the AR display data via the wireless communication unit 41 to the AR glasses 5. The AR glasses 5 displays the received AR display data for the rider to directly view and understand the current mode setting information or shock absorption effect setting information of the shock absorber 9.

The USB Type-C port 46 can be used to be electrically connected to other electronic devices or charging devices to facilitate software updates and charging.

Since the insertion of the USB Type-C port 46 has no directionality, and the USB type- A and micro USB connectors have directionality, it can improve the previous problem that USB type-A and micro USB often take time to plug into the USB port correctly when adopting the USB Type-C port 46 design, and this makes it more convenient to use.

The maximum transmission efficiency of the USB Type-C port 46 can reach 10 Gbps. The USB Type-C port 46 supports fast charging and has a maximum output power of 100 watts.

The USB Type-C port 46 can be used to replace a HDMI port, a VGA port and a display port.

Since the AR glasses 5 can display information for the rider to view, it is an existing technology, there are many types of AR glasses 5, and it is not the focus of improvement of the present disclosure, the AR glasses 5 will not be described in detail and the implementation of the AR glasses is not limited to the drawings.

In summary, through the structural design of the driving unit 32, the return detection unit 33 and the control unit 34 of the resistance adjustment device 3, the telescopic resistance of the shock absorber 9 can be automatically and accurately adjusted, thereby accurately controlling the shock absorption effect of the shock absorber.

The shock absorber control system 200 can be further operated through the wireless remote controller 4 to be switched to one of the multi-button control mode, the rotary knob control mode, the stepless control mode, the road mode, the off-road mode and the customize mode. By adopting the mode-switchable design, it is convenient for users to adjust and set to adjust and set the shock absorption effect of the shock absorber 9 according to their riding needs. Therefore, the shock absorber control system 200 used in the shock absorber 9 of the present disclosure is indeed a very innovative, convenient and practical creation, and can indeed achieve the purpose of the present disclosure.

The foregoing summarizes the features of the embodiments of the present disclosure so that those skilled in the art can better understand aspects of the present disclosure. Those skilled in the art should appreciate that they may readily use the present disclosure as a basis for designing or modifying other processes and structures for realizing the same purposes and/or achieving the same advantages of the embodiments introduced herein. Those skilled in the art should also recognize that such equivalent constructions do not depart from the spirit and scope of the present disclosure, and that they can be variously modified, substituted, and altered herein without departing from the spirit and scope of the present disclosure.

1. A shock absorber control system used in a shock absorber, the shock absorber comprises a telescopic pillar module and an adjustment pillar module for adjusting a telescopic resistance of the telescopic pillar module, and the shock absorber control system comprises a resistance adjustment device, wherein the resistance adjustment device comprises:
a shell structure, installed in and fixed to the telescopic pillar module;
a driving unit, installed in the shell structure, comprising a transmission part, an encoder and a stepper motor, wherein the transmission part is connected to the adjustment pillar module, the stepper motor is connected between the transmission part and encoder, the stepper motor is used to be controlled to operate and drive the transmission part, so that the transmission part drives the adjustment pillar module to adjust the telescopic resistance of the telescopic pillar module, and the encoder is used to sense a rotation angle of the stepper motor and generate an angle signal;
a return detection unit, comprising a detector and a positioning part, wherein the detector is installed in the shell structure, the positioning part is installed in the transmission part and linked by the transmission part to rotate relative to the detector, and the detector is used to generate a return signal when the positioning part is detected by the detector; and
a control unit, installed in the shell structure, signally connected to the driving unit and the return detection unit, wherein when the control unit is controlled to adjust the rotation angle of the stepper motor, the rotation angle corresponding to the angle signal is recorded, when the control unit is triggered by a wake-up signal, the control unit controls the stepper motor to rotate in a direction where the rotation angle becomes smaller until the control unit receives the return signal, and then the control unit controls the stepper motor to rotate to the last recorded rotation angle.

2. The shock absorber control system used in the shock absorber of claim 1, wherein the shock absorber control system is utilized accompanying with a battery, the shell structure comprises a shell body, a battery holder and a battery cover, the shell body is used to fix the telescopic pillar module, the battery holder is connected to the shell body and electrically connected to the control unit, such the battery is installed in the battery holder to and electrically connected to the battery holder, the battery cover is detachably installed on the battery holder and covers the battery, and the driving unit, the return detection unit and the control unit are installed in the shell body.

3. The shock absorber control system used in the shock absorber of claim 1, wherein the control unit further comprises a wireless communication module and a control module, the wireless communication module is used to wirelessly receive a resistance adjustment signal and the wake-up signal, the control module correspondingly controls the rotation angle of the stepper motor according to the resistance adjustment signal, and records the corresponding rotation angle of the angle signal, the control module is awakened and triggered by the wake-up signal, the stepper motor is firstly controlled to rotate in the direction where the rotation angle becomes smaller until the control unit receives the return signal, and then the control module controls the stepper motor to rotate to the last recorded rotation angle.

4. The shock absorber control system used in the shock absorber of claim 3, further comprising a wireless remote controller, the wireless remote controller comprises a display unit, a wireless communication unit and a main control unit, the wireless communication unit is signally connected to the wireless communication module, the main control unit comprises a power button and a plurality of fine adjustment buttons, the main control unit has a built-in multi-button control mode, when the main control unit is controlled to activate the multi-button control mode, the fine adjustment buttons are used to be operated to adjust and set the rotation angle, and the display unit displays the rotation angle, when the fine adjustment buttons are operated every time, the main control unit gradually increases or decreases the rotation angle by a predetermined value, and generates the corresponding resistance adjustment signal according to the adjusted and set rotation angle, and when the power button is operated to power on the wireless remote controller, the main control unit generates the wake-up signal, and the wireless communication unit wirelessly transmits the resistance adjustment signal and the wake-up signal to the wireless communication module.

5. The shock absorber control system used in the shock absorber of claim 4, wherein the main control unit further comprises a fully open button and a fully close button, when the main control unit is operated to activate the multi-button control mode, a maximum rotation angle is able to be directly sct by operating the fully open button, and a minimum rotation angle is able to be directly set by operating the fully close button, and the rotation angle is displayed on the display unit.

6. The shock absorber control system used in the shock absorber of claim 5, wherein the main control unit further comprises a rotary knob and a mode switching button, and has a built-in rotary knob control mode, when the mode switching button is operated, the main control unit is switched between the multi-button control mode and the rotary knob control mode, and when the main control unit is switched to the rotary knob control mode, the rotation angle is set by rotating the rotary knob, and the rotation angle is displayed on the display unit.

7. The shock absorber control system used in the shock absorber of claim 5, wherein the main control unit further comprises a stepless adjustment button and a mode switching button, and has a built-in stepless adjustment control mode, when the mode switching button is operated, the main control unit is switched between the multi-button control mode and stepless adjustment control mode, and when the main control unit is switched to the stepless adjustment control mode, the rotation angle is adjusted in a gradually increasing or decreasing manner while pressing the stepless adjustment button, and the rotation angle is displayed on the display unit.

8. The shock absorber control system used in the shock absorber of claim 4, wherein the shock absorber control system is adapted to be install on a bicycle having the shock absorber, the rotation angle of the stepper motor is adjusted between 0 and 90 degrees, the shock absorber has a maximum telescopic resistance when the rotation angle is 0 degree, the shock absorber has a minimum telescopic resistance when the rotation angle is 90 degrees, the wireless remote controller is installed on the bicycle, and also comprises an acceleration sensing unit and a gyroscope, the acceleration sensing unit is used to sense an acceleration variation to generate an acceleration signal, the gyroscope is used to sense an angular momentum variation to generate an angular velocity signal, the main control unit also is built-in with a road mode and an off-road mode, the main control unit is activated and switched to one of the road mode and the off-road mode; when the main control unit is switched to the road mode: the main control unit calculates and analyzes an acceleration represented by the acceleration signal and an angular velocity represented by the angular velocity signal to obtain a gravity value, and uses a predetermined function to calculate the corresponding rotation angle based on the gravity value, the main control unit generates the resistance adjustment signal based on the rotation angle while the rotation angle is between 0 and 45 degrees; when the main control unit is switched to the off-road mode: the main control unit calculates and analyzes the acceleration represented by the acceleration signal and the angular velocity represented by the angular velocity signal to obtain the gravity value, and uses the predetermined function to calculate the corresponding rotation angle based on the gravity value, the main control unit generates the resistance adjustment signal based on the rotation angle while the rotation angle is between 35 and 90 degrees.

9. The shock absorber control system used in the shock absorber of claim 8, wherein the main control unit is also built-in with a customized mode, the main control unit is activated and switched to one of the road mode, the off-road mode and the customized mode, when the main control unit is switched to the customized mode: the main control unit is operated to set a lower limitation value and an upper limitation value, the main control unit calculates and analyzes the acceleration represented by the acceleration signal and the angular velocity represented by the angular velocity signal to obtain the gravity value, and uses the predetermined function to calculate the corresponding rotation angle based on the gravity value, the main control unit generates the resistance adjustment signal based on the rotation angle while the rotation angle is larger than and equal to the lower limitation value and less than and equal to the upper limitation value, and the display unit displays the rotation angle.

10. The shock absorber control system used in the shock absorber of claim 2, wherein the shock absorber also has a shock absorber outer tube that is sleeved outside the telescopic pillar module, the shell body of the resistance adjustment device has a locking part and a sleeve part, locking part is screw-locked to the shock absorber outer tube, and the sleeve part is sleeved outside and fixed to the adjustment pillar module.

11. The shock absorber control system used in the shock absorber of claim 4, further comprising an augmented reality (AR) glasses signally connected to the wireless remote controller, the main control unit generates an AR display data according to the rotation angle which is generated based on the resistance adjustment signal, and transmits the AR display data to the AR glasses through the wireless communication unit, and the AR glasses displays the AR display data.

12. The shock absorber control system used in the shock absorber of claim 4, wherein the resistance adjustment device further comprises a USB Type-C port signally connected to the control unit.

13. The shock absorber control system used in the shock absorber of claim 4, wherein the wireless remote controller further comprises a USB Type-C port signally connected to the main control unit.
